(19) United States
(12) Patent Application Publication
(10) Pub. No.: US 2019/0089242 A1
(43) Pub. Date: Mar. 21, 2019

(54) POWER SUPPLY DEVICE AND METHOD OF CONTROLLING POWER SUPPLY DEVICE

(71) Applicant: SHINDENGEN ELECTRIC MANUFACTURING CO., LTD., Chiyoda-ku (JP)

(72) Inventors: Shinya IIJIMA, Hanno-shi (JP); Shigeru HISADA, Hanno-shi (JP)

(73) Assignee: SHINDENGEN ELECTRIC MANUFACTURING CO., LTD., Chiyoda-ku (JP)

(21) Appl. No.: 16/084,295

(22) PCT Filed: Jun. 28, 2016
(86) PCT No.: PCT/JP2016/069065

§ 371 Date: Sep. 12, 2018

(51) Int. Cl. H02M 1/42; H02M 3/158; G05F 1/70

(52) U.S. Cl. CPC H02M 1/4225; G05F 1/70; H02M 3/1584

(57) ABSTRACT

A power supply device according to the present invention detects a value of an input voltage (power supply voltage) by an input side voltage detection circuit, and decreases a comparative voltage (error voltage) that is compared with an on timer signal (timer signal) for determining an on time of a switching element based on the value of the input voltage. The power supply device employs an on-time control and at the same time reduces the total harmonic distortion.

### TECHNICAL FIELD

The present invention relates to a power supply device and a method of controlling a power supply device.

### BACKGROUND ART

Some of conventional power supply devices include a power factor correction (PFC) circuit (for example, see Patent Document 1).

The power factor correction circuit may be controlled by a current detection control method or an on-time control method. In the on-time control method, a current detection threshold value is set based on an input voltage waveform. Therefore, no multiplier is needed, unlike the current detection control method. This provides an advantage in that the circuit area of an integrated circuit for the control operation may be reduced to in turn reduce the costs.

However, the on-time control method has a problem in that the total harmonic distortion (THD) becomes greater than that in the current detection control method.

### PRIOR ART DOCUMENT

### Patent Document

### [Patent Document 1] JP 2008-199896 A

### SUMMARY OF THE INVENTION

### Problem to be Solved by the Invention

It is an object of the present invention to provide a power supply device that employs an on-time control method but may reduce the total harmonic distortion.

### Solution to Problem

A power supply device according to an embodiment in an aspect of the present invention is a power supply device including a power factor correction circuit and configured to supply power to a load, the power supply device comprising:

an AC power supply configured to output an AC voltage between a first input terminal and a second input terminal;

a rectifier circuit connected between the first input terminal and the second input terminal and configured to output, between a first power supply terminal and a second power supply terminal, a power supply voltage obtained by rectifying the AC voltage supplied from the AC power supply;

a first load terminal connected to a high potential side terminal of the load and a second load terminal connected to the second power supply terminal and a low potential side terminal of the load;

an input side voltage detection circuit connected between the first power supply terminal and the second power supply terminal, and configured to detect an input side detected voltage based on the power supply voltage;

an output side voltage detection circuit connected between the first load terminal and the second load terminal, and configured to detect an output side detected voltage based on an output voltage between the first load terminal and the second load terminal;

a primary side winding having one end that is connected to the first power supply terminal, the primary side winding being included in a transformer;

a secondary side winding having one end that is connected to the second power supply terminal, the secondary side winding being included in the transformer;

a main switch having one end that is connected to another end of the primary side winding and another end that is connected to the second load terminal;

an error amplifier configured to output an error voltage based on a difference between the output side detected voltage and a predefined reference voltage;

a subtractor configured to output a subtraction result signal based on a result of a subtraction of the input side detected voltage from the error voltage;

an output comparator configured to output a comparison result signal based on a result of a comparison between the subtraction result signal and a timer signal; and

a flip-flop circuit having a set terminal to which a signal from another end of the secondary side winding is inputted, a reset terminal to which the comparison result signal is inputted, and an output terminal from which a control signal for turning on or off the main switch is outputted.

The power supply device further comprises a timer circuit configured to output the timer signal based on the control signal.

In the power supply device,

wherein the timer circuit includes:

a constant current source having an output terminal connected to an inverting input terminal of the output comparator, the constant current source being configured to output a constant current;

a timer switch having an input/output terminal that is connected to the inverting input terminal of the output comparator, another input/output terminal that is grounded, and a control terminal that is connected to an inverted output terminal of the flip-flop circuit; and

a timer capacitor having one end that is connected to the input/output terminal of the timer switch.

In the power supply device,

wherein the subtractor includes:

a first resistor having one end that is connected to the input side voltage detection circuit;

a second resistor having one end that is connected to an output terminal of the error amplifier;

an amplifier having an inverting input terminal that is connected to another end of the first resistor, a non-inverting input terminal that is connected to another end of the second resistor, and an output terminal that is connected to an inverting input terminal of the output comparator;

a third resistor having one end that is connected to the inverting input terminal of the amplifier and another end that is connected to the output terminal of the amplifier; and

a fourth resistor having one end that is connected to the non-inverting input terminal of the amplifier and another end that is grounded.

A power supply device includes a power factor correction circuit and configured to supply power to a load, the power supply device comprising:

an AC power supply configured to output an AC voltage between a first input terminal and a second input terminal;

a rectifier circuit connected between the first input terminal and the second input terminal and configured to output, between a first power supply terminal and a second power supply terminal, a power supply voltage obtained by rectifying the AC voltage supplied from the AC power supply;

a first load terminal connected to a high potential side terminal of the load and a second load terminal connected to the second power supply terminal and a low potential side terminal of the load;

an input side voltage detection circuit connected between the first power supply terminal and the second power supply terminal, and configured to detect an input side detected voltage based on the power supply voltage;

an output side voltage detection circuit connected between the first load terminal and the second load terminal, and configured to detect an output side detected voltage based on an output voltage between the first load terminal and the second load terminal;

a primary side winding having one end that is connected to the first power supply terminal, the primary side winding being included in a transformer;

a secondary side winding having one end that is connected to the second power supply terminal, the secondary side winding being included in the transformer;

a main switch having one end that is connected to another end of the primary side winding and another end that is connected to the second load terminal;

an error amplifier configured to output an error voltage based on a difference between the output side detected voltage and a predefined reference voltage;

an adder configured to output an addition result signal based on a result of an addition of a timer signal and the input side detected voltage;

an output comparator configured to output a comparison result signal based on a result of a comparison between the addition result signal and the error voltage; and

a flip-flop circuit having a set terminal to which a signal from another end of the secondary side winding is inputted, a reset terminal to which the comparison result signal is inputted, and an output terminal from which a control signal for turning on or off the main switch is outputted.

The power supply device further comprises a timer circuit configured to output the timer signal based on the control signal.

In the power supply device,

wherein the timer circuit includes:

a constant current source having an output that is connected to an input terminal of the adder, the constant current source being configured to output a constant current;

a timer switch having an input/output terminal that is connected to the input terminal of the adder, another input/output terminal that is grounded, and a control terminal that is connected to an inverted output terminal of the flip-flop circuit; and

a timer capacitor having one end that is connected to the input/output terminal of the timer switch.

In the power supply device,

wherein the adder includes:

a first resistor having one end that is grounded;

a second resistor having one end that is connected to the input side voltage detection circuit;

a third resistor having one end that is connected to an output terminal of the timer circuit;

an amplifier having an inverted output terminal that is connected to another end of the first resistor, a non-inverting input terminal that is connected to another end of the second resistor and another end of the third resistor, and an output terminal that is connected to an inverting input terminal of the output comparator;

a fourth resistor having one end that is connected to the inverting input terminal of the amplifier and another end that is connected to the output terminal of the amplifier; and

a fifth resistor having one end that is connected to the non-inverting input terminal of the amplifier and another end that is grounded.

A method of controlling a power supply device according to an embodiment in an aspect of the present invention is a method of controlling a power supply device including a power factor correction circuit and configured to supply power to a load, the power supply device comprising: an AC power supply configured to output an AC voltage between a first input terminal and a second input terminal; a rectifier circuit connected between the first input terminal and the second input terminal and configured to output, between a first power supply terminal and a second power supply terminal, a power supply voltage obtained by rectifying the AC voltage supplied from the AC power supply; a first load terminal connected to a high potential side terminal of the load and a second load terminal connected to the second power supply terminal and a low potential side terminal of the load; an input side voltage detection circuit connected between the first power supply terminal and the second power supply terminal, and configured to detect an input side detected voltage based on the power supply voltage; an output side voltage detection circuit connected between the first load terminal and the second load terminal, and configured to detect an output side detected voltage based on an output voltage between the first load terminal and the second load terminal; a primary side winding having one end that is connected to the first power supply terminal, the primary side winding being included in a transformer; a secondary side winding having one end that is connected to the second power supply terminal, the secondary side winding being included in the transformer; a main switch having one end that is connected to another end of the primary side winding and another end that is connected to the second load terminal; an error amplifier configured to output an error voltage based on a difference between the output side detected voltage and a predefined reference voltage; an adder configured to output an addition result signal based on a result of an addition of a timer signal and the input side detected voltage; an output comparator configured to output a comparison result signal based on a result of a comparison between the addition result signal and the error voltage; and a flip-flop circuit having a set terminal to which a signal from another end of the secondary side winding is inputted, a reset terminal to which the comparison result signal is inputted, and an output terminal from which a control signal for turning on or off the main switch is outputted,

the method comprising:

outputting, by the subtractor, the subtraction result signal based on the result of the subtraction of the input side detected voltage from the error voltage; and

outputting, by the output comparator, the comparison result signal based on the result of the comparison between the subtraction result signal and the timer signal.

The method of controlling a power supply device including a power factor correction circuit and configured to supply power to a load, the power supply device comprising: an AC power supply configured to output an AC voltage between a first input terminal and a second input terminal; a rectifier circuit connected between the first input terminal and the second input terminal, and configured to output, between a first power supply terminal and a second power supply terminal, a power supply voltage obtained by rectifying the AC voltage supplied from the AC power supply; a first load terminal connected to a high potential side terminal of the load and a second load terminal connected to the second power supply terminal and a low potential side terminal of the load; an input side voltage detection circuit connected between the first power supply terminal and the second power supply terminal, and configured to detect an input side detected voltage based on the power supply voltage; an output side voltage detection circuit connected between the first load terminal and the second road terminal, and configured to detect an output side detected voltage based on an output voltage between the first load terminal and the second load terminal; a primary side winding having one end that is connected to the first power supply terminal, the primary side winding being included in a transformer; a secondary side winding having one end that is connected to the second power supply terminal, the secondary side winding being included in the transformer; a main switch having one end that is connected to another end of the primary side winding and another end that is connected to the second load terminal; an error amplifier configured to output an error voltage based on a difference between the output side detected voltage and a predefined reference voltage; an adder configured to output an addition result signal based on a result of an addition of a timer signal and the input side detected voltage; an output comparator configured to output a comparison result signal based on a result of a comparison between the addition result signal and the error voltage; and a flip-flop circuit having a set terminal to which a signal from another end of the secondary side winding is inputted, a reset terminal to which the comparison result signal is inputted, and an output terminal from which a control signal for turning on or off the main switch is outputted,

the method comprising:

outputting, by the adder, the addition result signal based on the result of the addition of the timer signal and the input side detected voltage; and

outputting, by the output comparator, the comparison result signal based on the result of the comparison between the addition result signal and the error voltage.

### Effects of the Invention

A power supply device according to an embodiment in an aspect of the present invention is a power supply device including a power factor correction circuit and configured to supply power to a load, the power supply device comprising: an AC power supply configured to output an AC voltage between a first input terminal and a second input terminal; a rectifier circuit connected between the first input terminal and the second input terminal and configured to output, between a first power supply terminal and a second power supply terminal, a power supply voltage obtained by rectifying the AC voltage supplied from the AC power supply; a first load terminal connected to a high potential side terminal of the load and a second load terminal connected to the second power supply terminal and a low potential side terminal of the load; an input side voltage detection circuit connected between the first power supply terminal and the second power supply terminal, and configured to detect an input side detected voltage based on the power supply voltage; an output side voltage detection circuit connected between the first load terminal and the second load terminal, and configured to detect an output side detected voltage based on an output voltage between the first load terminal and the second load terminal; a primary side winding having one end that is connected to the first power supply terminal, the primary side winding being included in a transformer; a secondary side winding having one end that is connected to the second power supply terminal, the secondary side winding being included in the transformer; a main switch having one end that is connected to another end of the primary side winding and another end that is connected to the second load terminal; an error amplifier configured to output an error voltage based on a difference between the output side detected voltage and a predefined reference voltage; a subtractor configured to output a subtraction result signal based on a result of a subtraction of the input side detected voltage from the error voltage; an output comparator configured to output a comparison result signal based on a result of a comparison between the subtraction result signal and a timer signal; and a flip-flop circuit having a set terminal to which a signal from another end of the secondary side winding is inputted, a reset terminal to which the comparison result signal is inputted, and an output terminal from which a control signal for turning on or off the main switch is outputted.

Thus, the value of the input voltage (power supply voltage) is detected by the input side voltage detection circuit, and the comparative voltage (error voltage) for the comparison with the on timer signal (timer signal) for determining the on time of the main switch SW is decreased depending on the value of the input voltage. As a result, the input voltage waveform (waveform of the power supply voltage) is shaped to reduce the total harmonic distortion.

Thus, the power supply device according to the present invention is capable of employing the on-time control and at the same time reducing the total harmonic distortion.

### BRIEF DESCRIPTION OF THE DRAWINGS

FIG. 1 is a diagram illustrating an example of a configuration of a power supply device 100 according to a first embodiment in an aspect of the present invention.

FIG. 2 is a diagram illustrating an example of a specific configuration of a subtractor Z included in the power supply device 100 shown in FIG. 1.

FIG. 3 is a diagram illustrating an example of a specific configuration of a timer circuit TC included in the power supply device 100 shown in FIG. 1.

FIG. 4 is a waveform diagram showing an example of operational waveforms of the power supply device 100 shown in FIG. 1.

FIG. 5 is a diagram illustrating an example of a configuration of a power supply device 200 according to a second embodiment in an aspect of the present invention.

FIG. 6 is a diagram illustrating an example of a specific configuration of a timer circuit TC2 included in the power supply device 200 shown in FIG. 5.

FIG. 7 is a diagram illustrating an example of a specific configuration of an adder Z2 included in the power supply device 200 shown in FIG. 5.

FIG. 8 is a waveform diagram showing an example of respective waveforms of the power supply device 200 shown in FIG. 5.

### EMBODIMENTS FOR CARRYING OUT THE INVENTION

Embodiments of the present invention will now be described with reference to the accompanying drawings.

### First Embodiment

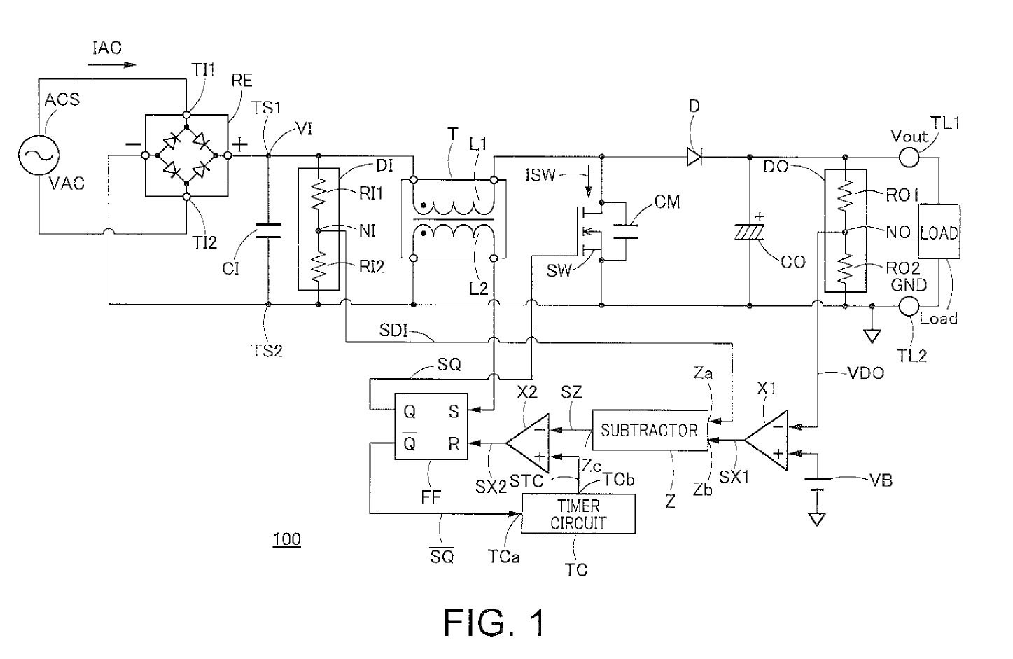

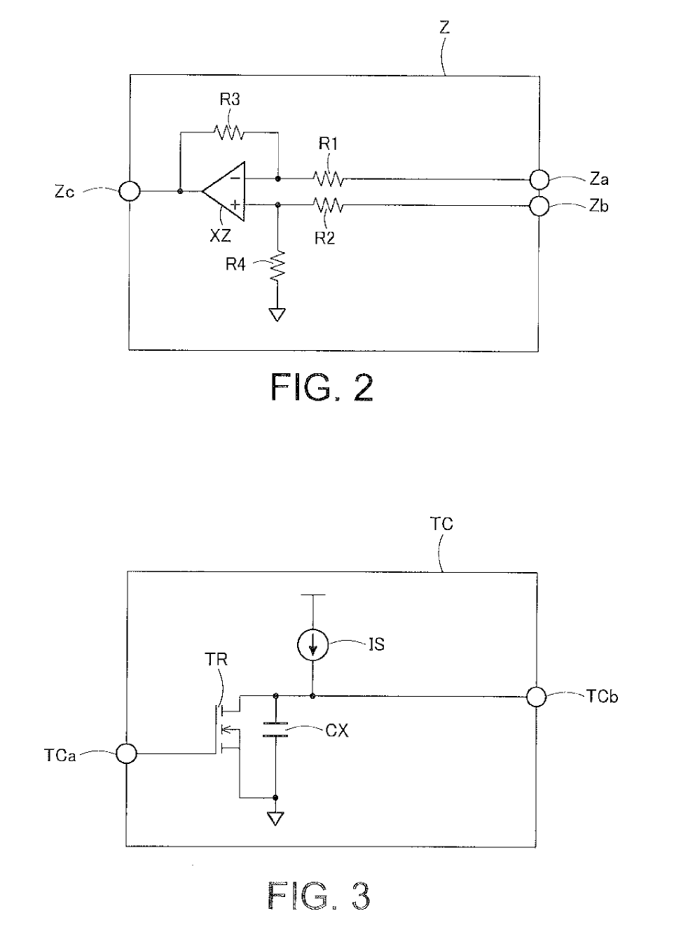

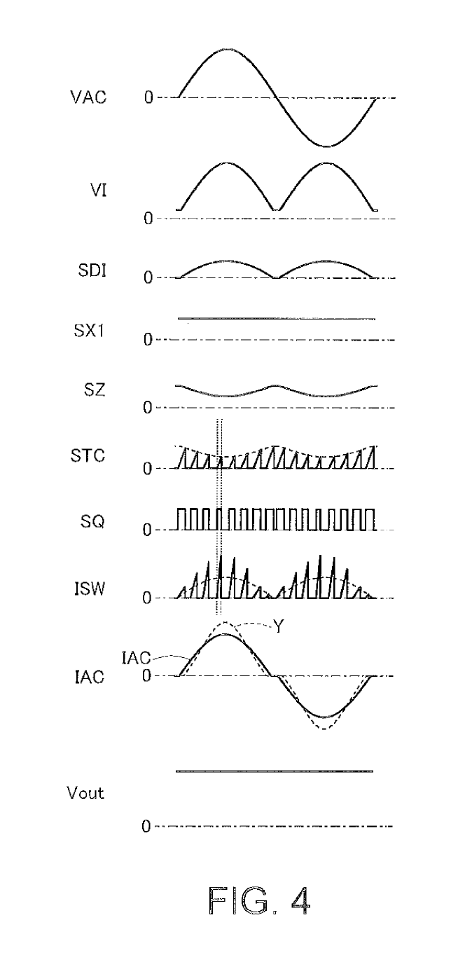

FIG. 1 is a diagram illustrating an example of a configuration of a power supply device 100 according to a first embodiment in an aspect of the present invention. FIG. 2 is a diagram illustrating an example of a specific configuration of a subtractor Z included in the power supply device 100 shown in FIG. 1. FIG. 3 is a diagram illustrating an example of a specific configuration of a timer circuit TC included in the power supply device 100 shown in FIG. 1. FIG. 4 is a waveform diagram showing an example of operational waveforms of the power supply device 100 shown in FIG. 1.

As shown in FIG. 1, for example, the power supply device 100 includes a power factor correction circuit and supplies power to a load Load.

The power supply device 100 includes an AC power supply ACS, a first input terminal TI1, a second input terminal TI2, a rectifier circuit RE, a first power supply terminal TS1, a second power supply terminal TS2, an input capacitor CI, a first load terminal TL1, a second load terminal TL2, an input side voltage detection circuit DI, an output side voltage detection circuit DO, an output capacitor CO, a transformer T (primary side winding L1, secondary side winding L2), a rectifier element D, a main switch SW, a subtractor Z, an output comparator X2, a flip-flop circuit FF, a timer circuit TC and an error amplifier X1, as shown in FIG. 1.

For example, the AC power supply ACS outputs an AC voltage VAC (FIG. 4) between the first input terminal TI1 and the second input terminal TI2.

The rectifier circuit RE is connected between the first input terminal TI1 and the second input terminal T12, as shown in, for example, FIG. 1. The rectifier circuit RE outputs a power supply voltage VI (FIG. 4), which is obtained by rectifying the AC voltage VAC supplied from the AC power supply ACS, between the first power supply terminal TS1 and the second power supply terminal TS2.

The first load terminal TL1 is connected to a high potential side terminal of the load Load, as shown in, for example, FIG. 1.

The second load terminal TL2 is connected to the second power supply terminal TS2 and a low potential side terminal of the load Load, as shown in, for example, FIG. 1. The second load terminal TL2 is also grounded.

The input side voltage detection circuit DI is connected to the first power supply terminal TS1 and the second power supply terminal TS2. The input side voltage detection circuit DI detects an input side detected voltage SDI based on a power supply voltage VI between the first power supply terminal TS1 and the second power supply terminal TS2, and outputs the input side detected voltage SDI from an input side voltage dividing node NI. The input side detected voltage SDI here is a divided voltage of the power supply voltage VI (FIG. 4), as shown in, for example, FIG. 1.

The input side voltage detection circuit DI includes a first input side voltage dividing resistor RI1 and a second input side voltage dividing resistor R12, as shown in, for example, FIG. 1.

The first input side voltage dividing resistor RI1 has one end that is connected to the first power supply terminal TS1 and another end that is connected to the input side voltage dividing node NI.

The second input side voltage dividing resistor RI2 has one end that is connected to the second power supply terminal TS2 and another end that is connected to the input side voltage dividing node NI.

Thus, the input side voltage detection circuit DI is an input side voltage dividing circuit, which outputs an input side detected voltage SDI to the input side voltage dividing node NI, the input side detected voltage SDI being the divided voltage of the power supply voltage VI.

The output side voltage detection circuit DO is connected to the first load terminal TL1 and the second load terminal TL2. The output side voltage detection circuit DO detects an output side detected voltage VDO based on an output voltage Vout between the first load terminal TL1 and the second load terminal TL2, and outputs the output side detected voltage VDO from an output side voltage dividing node NO. The output side detected voltage VDO here is a divided voltage of the output voltage Vout between the first load terminal TL1 and the second load terminal TL2, as shown in, for example, FIG. 1.

The output side voltage detection circuit DO includes a first output side voltage dividing resistor RO1 and a second output side voltage dividing resistor R02, as shown in, for example, FIG. 1.

The first output side voltage dividing resistor RO1 has one end that is connected to the first load terminal TL1 and another end that is connected to the output side voltage dividing node NO.

The second output side voltage dividing resistor RO2 has one end that is connected to the second load terminal TL2 and another end that is connected to the output side voltage dividing node NO.

Thus, the output side voltage detection circuit DO is an output side voltage dividing circuit, which outputs the output side detected voltage VDO from the output side voltage dividing node NO, the output side detected voltage VDO being the divided voltage of the output voltage Vout.

The output capacitor CO is connected to the first load terminal TL1 and the second load terminal TL2. The output capacitor CO smoothies the output voltage Vout.

The primary side winding L1 has one end that is connected to the first power supply terminal TS1. The primary side winding L1 is included in the transformer T.

The secondary side winding L2 has one end that is connected to the second power supply terminal TS2. The secondary side winding L2 is included in the transformer T together with the primary side winding L1.

The rectifier element D has one end that is connected to another end of the primary side winding L1 and another end that is connected to the first load terminal TL1. A direction from the other end of the primary side winding L1 to the first load terminal TL1 is the forward direction of the rectifier element D.

The rectifier element D is a diode having an anode that is connected to the other end of the primary side winding L1 and a cathode that is connected to the first load terminal TL1, as shown in, for example, FIG. 1.

The main switch SW has one end that is connected to the other end of the primary side winding L1 and another end that is connected to the second load terminal TL2. The main switch SW is turned on or off by a pulse signal SQ, which is a control signal.

As shown in FIG. 1 for example, the main switch SW is an nMOS transistor having a drain that is connected to the other end of the primary side winding L1, a source that is connected to the second load terminal TL2, and a gate to which the pulse signal SQ is applied. The main switch SW is turned on when the pulse signal SQ shown in FIG. 4 is at a “High” level, and turned off when the pulse signal SQ is at a “Low” level, for example. Although the main switch SW is the nMOS transistor in this embodiment, such a device as a SIC power device, a GaN power device, a silicon power device, or an IGBT may also be used as the main switch SW.

A control capacitor CM is provided, which has one end that is connected to one end (drain) of the main switch SW and another end that is connected to another end (source) of the main switch SW.

The error amplifier X1 outputs an error voltage SX1 that is based on a difference between the output side detected voltage VDO and a predefined reference voltage VB,

The error amplifier X1 has an inverting input terminal to which the output side detected voltage VDO is supplied, and a non-inverting input terminal to which the reference voltage VB is supplied, as shown in, for example, FIG. 1.

In the example of FIG. 4, the error voltage SX1 outputted from the error amplifier X1 is constant since the output voltage Vout (output side detected voltage VDO) is constant.

The subtractor Z outputs a subtraction result signal SZ based on a result of a subtraction of the input side detected voltage SDI from the error voltage SX1 (FIG. 4).

The subtractor Z includes an amplifier XZ, a first resistor R1, a second resistor R2, a third resistor R3, and a fourth resistor R4, as shown in, for example, FIG. 2.

The first resistor R1 has one end that is connected to the input side voltage dividing node NI of the input side voltage detection circuit DI (an input terminal Za of the subtractor Z).

The second resistor R2 has one end that is connected to an output terminal of the error amplifier X1 (an input terminal Zb of the subtractor Z).

The amplifier XZ has an inverting output terminal that is connected to another end of the first resistor R1, a non-inverting input terminal that is connected to another end of the second resistor R2, and an output terminal that is connected to an inverting input terminal of the output comparator X2 (an output terminal Zc of the subtractor Z).

The third resistor R3 has one end that is connected to the inverting input terminal of the amplifier XZ and another end that is connected to the output terminal of the amplifier XZ.

The fourth resistor R4 has one end that is connected to the non-inverting input terminal of the amplifier XZ and another end that is grounded.

As described above, the subtractor Z having the configuration shown in FIG. 2 outputs, from the output terminal Zc, the subtraction result signal SZ obtained by subtracting the input side detected voltage SDI supplied to the input terminal Za from the error voltage SX1 supplied to the input terminal Zb.

The output comparator X2 outputs a comparison result signal SX2 based on a result of a comparison between the subtraction result signal SZ and a timer signal STC.

The output comparator X2 has a non-inverting input terminal, to which the timer signal STC is supplied from an output terminal TCb of the timer circuit TC, and an inverting input terminal, to which the subtraction result signal SZ is supplied from the output terminal Zc of the subtractor Z, as shown in, for example, FIG. 1.

If, for example, the voltage of the timer signal STC is less than the voltage of the subtraction result signal SZ, the output comparator X2 outputs the comparison result signal SX2 at a “Low” level. If the voltage of the timer signal STC is equal to or greater than the voltage of the subtraction result signal SZ, the output comparator X2 outputs the comparison result signal SX2 at a “High” level.

The flip-flop circuit FF has a set terminal S that is connected to another terminal of the secondary side winding L2 and a reset terminal R that is connected to an output terminal of the output comparator X2. The set terminal S of the flip-flop circuit FF receives a signal from the other end of the secondary side winding L2 and the reset terminal R receives the comparison result signal SX2 from the output comparator X2. The signal from the other end of the secondary side winding L2 varies depending on the current flowing through the primary side winding L1 (a current ISW (FIG. 4) flowing through the main switch SW).

The flip-flop circuit FF also has a non-inverted output terminal Q that is connected to a control terminal (gate) of the main switch SW, and an inverted output terminal /Q that is connected to an input terminal TCa of the timer circuit TC. The flip-flop circuit FF outputs a pulse signal SQ for turning on or off the main switch SW from the output terminal Q, and an inverted signal /SQ from the inverted output terminal /Q.

The timer circuit TC outputs the timer signal STC based on the inverted signal /SQ obtained by inverting the logic of the pulse signal SQ.

The timer circuit TC includes a constant current source IS, a switch (timer switch) TR, and a timer capacitor CX, as shown in, for example, FIG. 3.

The constant current source IS has an output terminal that is connected to the non-inverting input terminal of the output comparator X2 (the output terminal TCb of the timer circuit TC) and outputs a constant current.

The switch TR is an nMOS transistor (hereinafter, the “switch TR” may also be referred to as the “nMOS transistor TR”), having a drain that is connected to the non-inverting input terminal of the output comparator X2, a source that is grounded, and a gate that is connected to the inverted output terminal /Q of the flip-flop circuit FF (the input terminal TCa of the timer circuit TC). Although the switch TR is the nMOS transistor in this embodiment, such a device as a SiC power device, a GaN power device, a silicon power device, or an IGBT may also be used as the switch TR.

The timer capacitor CX has one end that is connected to the drain of the nMOS transistor TR (the output terminal TCb of the timer circuit TC).

Although the timer circuit TC has the above described configuration in this embodiment, a timer resistor, for example, may also be provided, which has one end that is connected to another end of the timer capacitor CX and another end that is connected to the source of the nMOS transistor TR (grounded). A power supply voltage may be provided instead of the timer resistor. The timer resistor or the power supply voltage may be provided between the ground and a connection point of the source of the nMOS transistor TR and the timer capacitor CX.

As shown in FIG. 4 for example, while the nMOS transistor TR is in the off state due to the inverted signal /SQ (“Low” level), the timer circuit TC outputs the timer signal STC depending on the voltage charged by the timer capacitor CX by the constant current outputted from the constant current source IS. When the nMOS transistor TR is turned on by the pulse of the inverted signal /SQ (“High” level), the electric charge of the timer capacitor CX is discharged and reset, and the timer signal STC is set at the ground voltage.

An example of an operation of the power supply device 100 having the above-described configuration will be described below.

For example, as described above, the error amplifier X1 outputs the error voltage SX1 based on the difference between the output side detected voltage VDO and the predefined reference voltage VB. In the example of FIG. 4, the error voltage SX1 outputted from the error amplifier X1 is constant since the output voltage Vout (output side detected voltage VDO) is constant.

The subtractor Z outputs, from the output terminal Zc, the subtraction result signal SZ obtained by subtracting the input side detected voltage SDI supplied to the input terminal Za from the error voltage SX1 supplied to the input terminal Zb (FIG. 4).

The output comparator X2 outputs the comparison result signal SX2 based on the comparison between the subtraction result signal SZ and the timer signal STC.

The flip-flop circuit FF receives, at the set terminal S, the signal from the other end of the secondary side winding L2 (signal that is dependent on the current ISW), receives, at the reset terminal R, the comparison result signal SX2, and outputs the pulse signal SQ for turning on or off the main switch SW and the inverted signal /SQ for controlling the timer signal STC.

Thus, the value of the input voltage (power supply voltage VI) is detected by the input side voltage detection circuit DI, and the comparative voltage (error voltage SX1) used for the comparison with an on timer signal (timer signal STC) used for determining the on time of the main switch SW is decreased depending on the value of the input voltage. As a result, the input voltage waveform (waveform of the power supply voltage VI) is shaped to reduce the total harmonic distortion (FIG. 4).

Thus, the power supply device 100 is capable of employing the on-time control and at the same time reducing the total harmonic distortion.

As described above, a power supply device in an aspect of the present invention includes an AC power supply ACS configured to output an AC voltage VAC between a first input terminal TI1 and a second input terminal T12, a rectifier circuit RE connected between the first input terminal TI1 and the second input terminal TI2 and configured to output a power supply voltage VI, which is obtained by rectifying the AC voltage VAC supplied from the AC power supply ACS, between a first power supply terminal TS1 and a second power supply terminal TS2, an input capacitor CI connected between the first power supply terminal TS1 and the second power supply terminal TS2, a first load terminal TL1 connected to a high potential side terminal of a load Load, a second load terminal TL2 connected to the second power supply terminal TS2 and a low potential side terminal of the load Load, a input side voltage detection circuit DI connected between the first power supply terminal TS1 and the second power supply terminal TS2 and configured to detect an input side detected voltage SDI based on a power supply voltage VI, an output side voltage detection circuit DO connected between the first load terminal TL1 and the second load terminal TL2 and configured to detect an output side detected voltage VDO based on an output voltage between the first load terminal TL1 and the second load terminal TL2, an output capacitor connected between the first load terminal TL1 and the second load terminal TL2, a primary side winding L1 having one end that is connected to the first power supply terminal TS1, the primary side winding L1 being included in a transformer, a rectifier element D having one end that is connected to another end of the primary side winding L1 and another end that is connected to the first load terminal TL1, a forward direction of the rectifier element D being from the other end of the primary side winding L1 to the first load terminal TL1, a secondary side winding L2 having one end that is connected to the second power supply terminal TS2, the secondary side winding L2 being included in the transformer, a main switch SW having one end that is connected to the other end of the primary side winding L1 and another end that is connected to the second load terminal TL2, an error amplifier X1 configured to output an error voltage SX1 based on a difference between an input side detected voltage SDI and a predefined reference voltage, a subtractor Z configured to output a subtraction result signal SZ based on a result of a subtraction of the output side detected voltage VDO from the error voltage SX1, an output comparator X2 configured to output a comparison result signal SX2 based on a result of a comparison between the subtraction result signal SZ and a timer signal STC, a flip-flop circuit FF having a set terminal to which a signal from the other end of the secondary side winding L2 is inputted, a reset terminal to which the comparison result signal SX2 is inputted, and an output terminal from which a pulse signal SQ for turning on or off the main switch SW is outputted, and a timer circuit TC configured to output a timer signal STC based on an inverted signal that is obtained by inverting a logic of the pulse signal SQ.

Thus, the value of the input voltage (power supply voltage VI) is detected by the input side voltage detection circuit DI, and the comparative voltage (error voltage SX1) for the comparison with the on timer signal (timer signal STC) for determining the on time of the main switch SW is decreased depending on the value of the input voltage. As a result, the input voltage waveform (waveform of the power supply voltage VI) is shaped to reduce the total harmonic distortion.

Thus, the power supply device according to the present invention is capable of employing the on-time control and at the same time reducing the total harmonic distortion.

### Second Embodiment

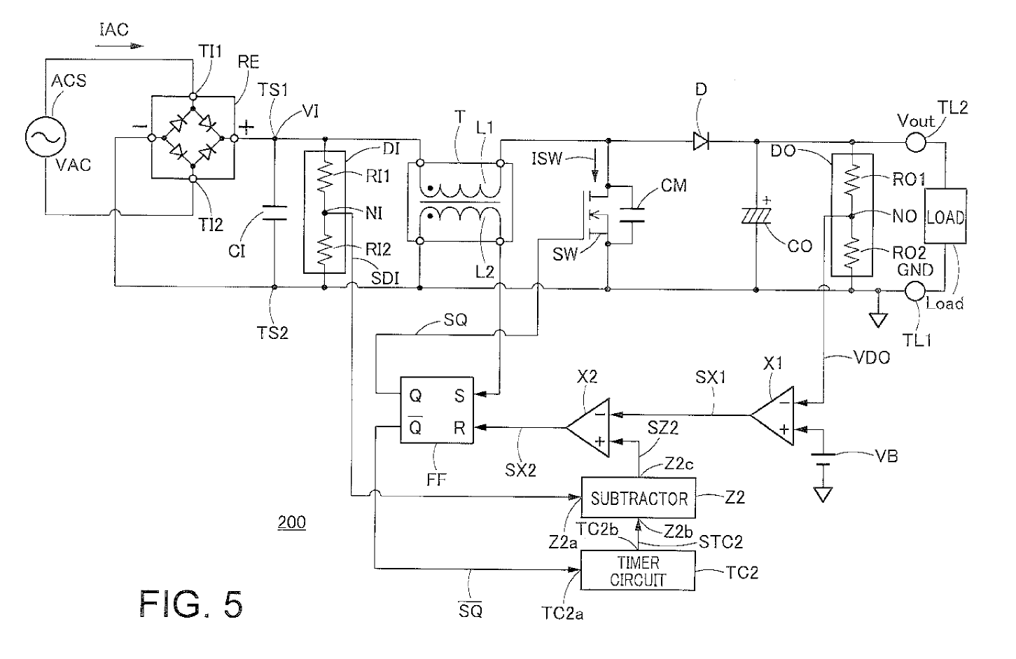

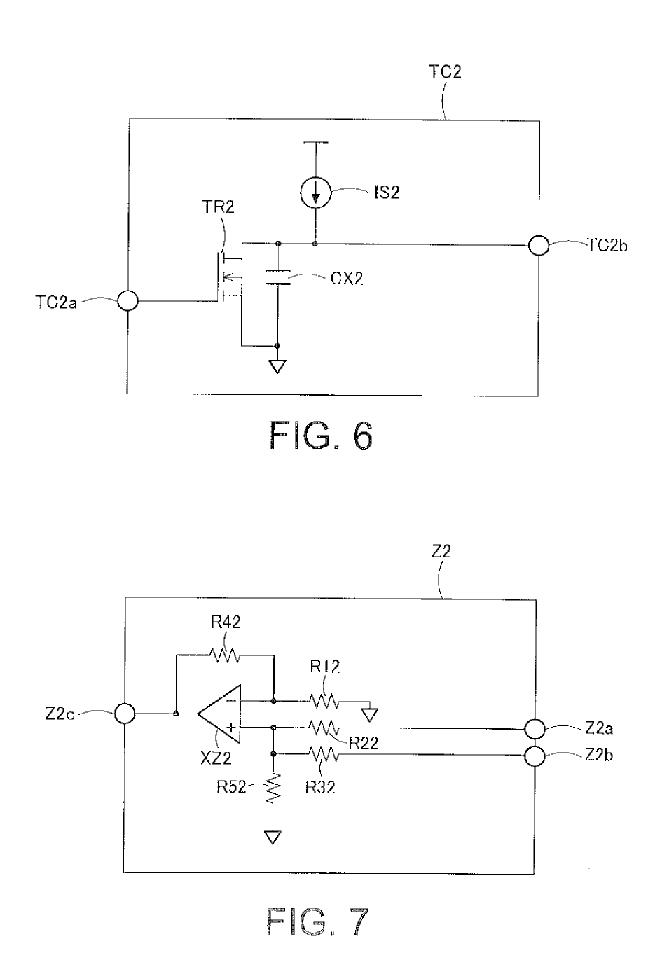

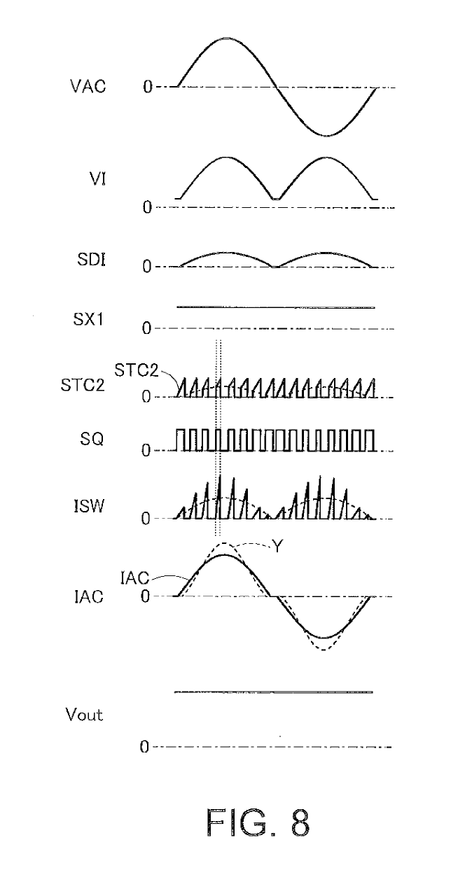

FIG. 5 is a diagram illustrating an example of a configuration of a power supply device 200 according to a second embodiment in an aspect of the present invention. FIG. 6 is a diagram illustrating an example of a specific configuration of a timer circuit TC2 included in the power supply device 200 shown in FIG. 5. FIG. 7 is a diagram illustrating an example of a specific configuration of an adder Z2 included in the power supply device 200 shown in FIG. 5. FIG. 8 is a waveform diagram showing an example of respective waveforms of the power supply device 200 shown in FIG. 5. In FIG. 5, the reference numerals that are the same as those in FIG. 1 indicate the same elements as the first embodiment.

As shown in FIG. 5, the power supply device 200 includes an AC power supply ACS, a first input terminal TI1, a second input terminal TI2, a rectifier circuit RE, a first power supply terminal TS1, a second power supply terminal TS2, an input capacitor CI, a first load terminal TL1, a second load terminal TL2, an input side voltage detection circuit DI, an output side voltage detection circuit DO, an output capacitor CO, a transformer T (primary side winding L1 and secondary side winding L2), a rectifier element D, a main switch SW, an adder Z2, an output comparator X2, a flip-flop circuit FF, a timer circuit TC2, and an error amplifier X1.

Specifically, the power supply device 200 according to the second embodiment shown in FIG. 5 includes the adder Z2 instead of the subtractor Z of the power supply device 100 shown in FIG. 1.

The error amplifier X1 outputs an error voltage SX1 based on a difference between an output side detected voltage VDO and a predefined reference voltage VB.

As shown in FIG. 5 for example, the error amplifier X1 has an inverting input terminal to which the output side detected voltage VDO is supplied, and a non-inverting input terminal to which the reference voltage VB is supplied.

In the example of FIG. 8, the error voltage SX1 outputted from the error amplifier X1 is constant since the output voltage Vout (output side detected voltage VDO) is constant.

The timer circuit TC2 outputs a timer signal STC2 based on an inverted signal /SQ obtained by inverting the logic of a pulse signal SQ, which is a control signal.

As shown in FIG. 6, for example, the timer circuit TC2 includes a constant current source IS2, a switch (timer switch) TR2, and a timer capacitor CX2.

The constant current source IS2 has an output terminal that is connected to an input terminal of the adder Z2 (an output terminal TC2b of the timer circuit TC2) and outputs a constant current.

The switch TR2 is an nMOS transistor (hereinafter, the “switch TR2” may also be referred to as the “nMOS transistor TR2”) having a drain that is connected to the input terminal of the adder Z2, a source that is grounded, and a gate that is connected to an inverted output terminal /Q of the flip-flop circuit FF (an input terminal TC2a of the timer circuit TC2). Although the switch TR2 is the nMOS transistor in this embodiment, such a device as a SiC power device, a GaN power device, a silicon power device, or an IGBT may also be used as the switch TR2.

The timer capacitor CX2 has one end that is connected to the drain of the nMOS transistor TR2 (the output terminal TC2b of the timer circuit TC2).

A timer resistor, for example, may be provided to the timer circuit TC2 of this embodiment, the timer resistor having one end that is connected to another end of the timer capacitor CX2 and another end that is connected to the source of the nMOS transistor TR2 (grounded). A power supply voltage may be provided instead of the timer resistor. The timer resistor or the power supply voltage may be provided between the ground and a connection point of the source of the nMOS transistor TR2 and the timer capacitor CX2.

As shown in FIG. 8, for example, while the nMOS transistor TR2 is in the off state due to the inverted signal /SQ (“Low” level), the timer circuit TC2 outputs the timer signal STC2 depending on the voltage charged by the timer capacitor CX2 by the constant current outputted from the constant current source IS2. When the nMOS transistor TR2 is turned on by the pulse of the inverted signal /SQ (“High” level), the electric charge of the timer capacitor CX2 is discharged and reset, and the timer signal STC2 is set at the ground voltage.

The adder Z2 outputs an addition result signal SZ2 based on a result of the addition of the timer signal STC2 and the input side detected voltage SDI.

As shown in FIG. 7, for example, the adder Z2 includes a first resistor R12, a second resistor R22, a third resistor R32, a fourth resistor R42, an amplifier XZ2, and a fifth resistor R52.

The first resistor R12 has one end that is grounded.

The second resistor R22 has one end that is connected to an input side voltage dividing node NI of the input side voltage detection circuit DI (an input terminal Z2a of the adder Z2).

The third resistor R32 has one end that is connected to an output terminal of the timer circuit TC2 (an input terminal Z2b of the adder Z2).

The amplifier XZ2 has an inverting input terminal that is connected to another end of the first resistor R12, a non-inverting input terminal that is connected to another end of the second resistor R22 and another end of the third resistor R32, and an output terminal that is connected to the non-inverting input terminal of the output comparator X2 (an output terminal Z2c of the adder Z2).

The fourth resistor R42 has one end that is connected to the inverting input terminal of the amplifier XZ2 (the other end of the first resistor R12) and another end that is connected to the output terminal of the amplifier XZ2 (the output terminal Z2c of the adder Z2).

The fifth resistor R52 has one end that is connected to the non-inverting input terminal of the amplifier XZ2 (the other end of the second resistor R22 and the other end of the third resistor R32) and another end that is grounded.

As described above, the adder Z2 having the configuration shown in FIG. 7 outputs from the output terminal Z2c the addition result signal SZ2 obtained by adding the input side detected voltage SDI supplied to the input terminal Z2a and the timer signal STC supplied to the input terminal Z2b.

The output comparator X2 outputs a comparison result signal SX2 based on a result of the comparison between the addition result signal SZ2 and the error voltage SX1.

The output comparator X2 has a non-inverting input terminal to which the addition result signal SZ2 is supplied via the output terminal Z2c of the adder Z2, and an inverting input terminal to which the error voltage SX1 outputted from the output comparator X1 is supplied.

For example, the output comparator X2 outputs the comparison result signal SX2 at a “Low” level when the voltage of the addition result signal SZ2 is less than the voltage of the error voltage SX1. The output comparator X2 outputs the comparison result signal SX2 at a “High” level when the voltage of the addition result signal SZ2 is equal to or greater than the voltage of the error voltage SX1.

As shown in FIG. 5, for example, the flip-flop circuit FF has a set terminal S that is connected to another end of the secondary side winding L2 and a reset terminal R that is connected to an output terminal of the output comparator X2. The flip-flop circuit FF receives a signal from the other end of the secondary side winding L2 at the set terminal S, and the comparison result signal SX2 from the output comparator X2 at the reset terminal R. The signal from the other end of the secondary side winding L2 varies depending on a current flowing through the primary side winding L1 (current ISW (FIG. 8) flowing through the main switch SW).

The flip-flop circuit FF further has a non-inverted output terminal Q that is connected to a control terminal (gate) of the main switch SW, and an inverted output terminal /Q that is connected to an input terminal TCa of the timer circuit TC. The flip-flop circuit FF outputs a pulse signal SQ for turning on or off the main switch SW from the non-inverted output terminal Q, and an inverted signal /SQ from the inverted output terminal /Q.

The other elements of the power supply device 200 are the same as those in the power supply device 100 according to the first embodiment shown in FIG. 1.

An example of an operation of the power supply device 200 having the above-described configuration will be described below.

For example, as described above, the error amplifier X1 outputs the error voltage SX1 based on the difference between the output side detected voltage VDO and the predefined reference voltage VB. In the example of FIG. 8, the error voltage SX1 outputted from the error amplifier X1 is constant since the output voltage Vout (output side detected voltage VDO) is constant.

The adder Z2 outputs the addition result signal SZ2 based on the result of the addition of the timer signal STC2 and the input side detected voltage SDI.

The output comparator X2 outputs the comparison result signal SX2 based on the result of the comparison between the addition result signal SZ2 and the error voltage SX1.

The flip-flop circuit FF receives the signal from the other end of the secondary side winding L2 (the signal depending on the current ISW) at the set terminal S, receives the comparison result signal SX2 at the reset terminal R, outputs the pulse signal SQ for turning on or off the main switch SW, and outputs the inverted signal /SQ for controlling the timer signal STC.

Thus, the value of the input voltage (power supply voltage VI) is detected by the input side voltage detection circuit DI, and an addition is performed on an on timer signal (timer signal STC) for determining the on time of the main switch SW, which is compared with the comparative voltage (error voltage SX1), based on the value of the input voltage. As a result, the input voltage waveform (waveform of power supply voltage VI) is shaped to reduce the total harmonic distortion (FIG. 8).

Thus, the power supply device 200 according to this embodiment employs an on-time control and at the same time reduces the total harmonic distortion, like the first embodiment.

While certain embodiments have been described, these embodiments have been presented by way of example only, and are not intended to limit the scope of the inventions. The embodiments may be embodied in a variety of other forms. Furthermore, various omissions, substitutions and changes in the form of the methods and systems described herein may be made without departing from the spirit of the inventions. The embodiments and their modifications are included in the scope and the subject matter of the invention, and at the same time included in the scope of the claimed inventions and their equivalents.

### EXPLANATION OF REFERENCES

100, 200: power supply device
ACS: AC power supply
TI1: first input terminal
TI2: second input terminal
RE: rectifier circuit
TS1: first power supply terminal
TS2: second power supply terminal
CI: input capacitor
TL1: first load terminal
TL2: second load terminal
DI: input side voltage detection circuit
DO: output side voltage detection circuit
CO: output capacitor
T: transformer
L1: primary side winding
L2: secondary side winding
D: rectifier element
SW: main switch
Z: subtractor
Z2: adder
X2: output comparator
FF: flip-flop circuit
TC: timer circuit
X1: error amplifier

1. A power supply device including a power factor correction circuit and configured to supply power to a load, the power supply device comprising:
an AC power supply configured to output an AC voltage between a first input terminal and a second input terminal;
a rectifier circuit connected between the first input terminal and the second input terminal and configured to output, between a first power supply terminal and a second power supply terminal, a power supply voltage obtained by rectifying the AC voltage supplied from the AC power supply;
a first load terminal connected to a high potential side terminal of the load and a second load terminal connected to the second power supply terminal and a low potential side terminal of the load;
an input side voltage detection circuit connected between the first power supply terminal and the second power supply terminal, and configured to detect an input side detected voltage based on the power supply voltage;
an output side voltage detection circuit connected between the first load terminal and the second load terminal, and configured to detect an output side detected voltage based on an output voltage between the first load terminal and the second load terminal;
a primary side winding having one end that is connected to the first power supply terminal, the primary side winding being included in a transformer;
a secondary side winding having one end that is connected to the second power supply terminal, the secondary side winding being included in the transformer;
a main switch having one end that is connected to another end of the primary side winding and another end that is connected to the second load terminal;
an error amplifier configured to output an error voltage based on a difference between the output side detected voltage and a predefined reference voltage;
a subtractor configured to output a subtraction result signal based on a result of a subtraction of the input side detected voltage from the error voltage;
an output comparator configured to output a comparison result signal based on a result of a comparison between the subtraction result signal and a timer signal; and
a flip-flop circuit having a set terminal to which a signal from another end of the secondary side winding is inputted, a reset terminal to which the comparison result signal is inputted, and an output terminal from which a control signal for turning on or off the main switch is outputted.

2. The power supply device according to claim 1, further comprising a timer circuit configured to output the timer signal based on the control signal.

3. The power supply device according to claim 2, wherein the timer circuit includes:
a constant current source having an output terminal connected to an inverting input terminal of the output comparator, the constant current source being configured to output a constant current;
a timer switch having an input/output terminal that is connected to the inverting input terminal of the output comparator, another input/output terminal that is grounded, and a control terminal that is connected to an inverted output terminal of the flip-flop circuit; and
a timer capacitor having one end that is connected to the input/output terminal of the timer switch.

4. The power supply device according to claim 1, wherein the subtractor includes:
a first resistor having one end that is connected to the input side voltage detection circuit;
a second resistor having one end that is connected to an output terminal of the error amplifier;
an amplifier having an inverting input terminal that is connected to another end of the first resistor, a non-inverting input terminal that is connected to another end of the second resistor, and an output terminal that is connected to an inverting input terminal of the output comparator;
a third resistor having one end that is connected to the inverting input terminal of the amplifier and another end that is connected to the output terminal of the amplifier; and
a fourth resistor having one end that is connected to the non-inverting input terminal of the amplifier and another end that is grounded.

5. The power supply device according to claim 1,
wherein the input side voltage detection circuit is an input side voltage dividing circuit connected between the first power supply terminal and the second power supply terminal, and configured to output the input side detected voltage, which is a divided voltage of the power supply voltage, from an input side voltage dividing node, the input side voltage dividing circuit including:
a first input side voltage dividing resistor having one end that is connected to the first power supply terminal and another end that is connected to the input side voltage dividing node; and
a second input side voltage dividing resistor having one end that is connected to the second power supply terminal and another end that is connected to the input side voltage dividing node, and
wherein the output side voltage detection circuit is an output side voltage dividing circuit connected between the first load terminal and the second load terminal, and configured to output the output side detected voltage, which is a divided voltage of the output voltage between the first load terminal and the second load terminal, from an output side voltage dividing node, the output side voltage dividing circuit including:
a first output side voltage dividing resistor having one end that is connected to the first load terminal and another end that is connected to the output side voltage dividing node; and
a second output side voltage dividing resistor having one end that is connected to the second load terminal and another end that is connected to the output side voltage dividing node.

6. A power supply device including a power factor correction circuit and configured to supply power to a load, the power supply device comprising:
an AC power supply configured to output an AC voltage between a first input terminal and a second input terminal;
a rectifier circuit connected between the first input terminal and the second input terminal and configured to output, between a first power supply terminal and a second power supply terminal, a power supply voltage obtained by rectifying the AC voltage supplied from the AC power supply;
a first load terminal connected to a high potential side terminal of the load and a second load terminal connected to the second power supply terminal and a low potential side terminal of the load;
an input side voltage detection circuit connected between the first power supply terminal and the second power supply terminal, and configured to detect an input side detected voltage based on the power supply voltage;
an output side voltage detection circuit connected between the first load terminal and the second load terminal, and configured to detect an output side detected voltage based on an output voltage between the first load terminal and the second load terminal;
a primary side winding having one end that is connected to the first power supply terminal, the primary side winding being included in a transformer;
a secondary side winding having one end that is connected to the second power supply terminal, the secondary side winding being included in the transformer;
a main switch having one end that is connected to another end of the primary side winding and another end that is connected to the second load terminal;
an error amplifier configured to output an error voltage based on a difference between the output side detected voltage and a predefined reference voltage;
an adder configured to output an addition result signal based on a result of an addition of a timer signal and the input side detected voltage;
an output comparator configured to output a comparison result signal based on a result of a comparison between the addition result signal and the error voltage; and
a flip-flop circuit having a set terminal to which a signal from another end of the secondary side winding is inputted, a reset terminal to which the comparison result signal is inputted, and an output terminal from which a control signal for turning on or off the main switch is outputted.

7. The power supply device according to claim 6, further comprising a timer circuit configured to output the timer signal based on the control signal.

8. The power supply device according to claim 7, wherein the timer circuit includes:
a constant current source having an output that is connected to an input terminal of the adder, the constant current source being configured to output a constant current;
a timer switch having an input/output terminal that is connected to the input terminal of the adder, another input/output terminal that is grounded, and a control terminal that is connected to an inverted output terminal of the flip-flop circuit; and
a timer capacitor having one end that is connected to the input/output terminal of the timer switch.

9. The power supply device according to claim 6, wherein the adder includes:
a first resistor having one end that is grounded;
a second resistor having one end that is connected to the input side voltage detection circuit;
a third resistor having one end that is connected to an output terminal of the timer circuit;
an amplifier having an inverted output terminal that is connected to another end of the first resistor, a non-inverting input terminal that is connected to another end of the second resistor and another end of the third resistor, and an output terminal that is connected to an inverting input terminal of the output comparator;
a fourth resistor having one end that is connected to the inverting input terminal of the amplifier and another end that is connected to the output terminal of the amplifier; and
a fifth resistor having one end that is connected to the non-inverting input terminal of the amplifier and another end that is grounded.

10. The power supply device according to claim 6,
wherein the input side voltage detection circuit is an input side voltage dividing circuit connected between the first power supply terminal and the second power supply terminal, and configured to output the input side detected voltage, which is a divided voltage of the power supply voltage, from an input side voltage dividing node, the input side voltage dividing circuit including:
a first input side voltage dividing resistor having one end that is connected to the first power supply terminal and another end that is connected to the input side voltage dividing node; and
a second input side voltage dividing resistor having one end that is connected to the second power supply terminal and another end that is connected to the input side voltage dividing node, and
wherein the output side voltage detection circuit is an output side voltage dividing circuit connected between the first load terminal and the second load terminal, and configured to output the output side detected voltage, which is a divided voltage of the output voltage between the first load terminal and the second load terminal, from an output side voltage dividing node, the output side voltage dividing circuit including:
a first output side voltage dividing resistor having one end that is connected to the first load terminal and another end that is connected to the output side voltage dividing node; and
a second output side voltage dividing resistor having one end that is connected to the second load terminal and another end that is connected to the output side voltage dividing node.

11. A method of controlling a power supply device including a power factor correction circuit and configured to supply power to a load, the power supply device comprising: an AC power supply configured to output an AC voltage between a first input terminal and a second input terminal; a rectifier circuit connected between the first input terminal and the second input terminal and configured to output, between a first power supply terminal and a second power supply terminal, a power supply voltage obtained by rectifying the AC voltage supplied from the AC power supply; a first load terminal connected to a high potential side terminal of the load and a second load terminal connected to the second power supply terminal and a low potential side terminal of the load; an input side voltage detection circuit connected between the first power supply terminal and the second power supply terminal, and configured to detect an input side detected voltage based on the power supply voltage; an output side voltage detection circuit connected between the first load terminal and the second load terminal, and configured to detect an output side detected voltage based on an output voltage between the first load terminal and the second load terminal; a primary side winding having one end that is connected to the first power supply terminal, the primary side winding being included in a transformer; a secondary side winding having one end that is connected to the second power supply terminal, the secondary side winding being included in the transformer; a main switch having one end that is connected to another end of the primary side winding and another end that is connected to the second load terminal; an error amplifier configured to output an error voltage based on a difference between the output side detected voltage and a predefined reference voltage; an adder configured to output an addition result signal based on a result of an addition of a timer signal and the input side detected voltage; an output comparator configured to output a comparison result signal based on a result of a comparison between the addition result signal and the error voltage; and a flip-flop circuit having a set terminal to which a signal from another end of the secondary side winding is inputted, a reset terminal to which the comparison result signal is inputted, and an output terminal from which a control signal for turning on or off the main switch is outputted, the method comprising:
outputting, by the subtractor, the subtraction result signal based on the result of the subtraction of the input side detected voltage from the error voltage; and
outputting, by the output comparator, the comparison result signal based on the result of the comparison between the subtraction result signal and the timer signal.

12. A method of controlling a power supply device including a power factor correction circuit and configured to supply power to a load, the power supply device comprising: an AC power supply configured to output an AC voltage between a first input terminal and a second input terminal; a rectifier circuit connected between the first input terminal and the second input terminal, and configured to output, between a first power supply terminal and a second power supply terminal, a power supply voltage obtained by rectifying the AC voltage supplied from the AC power supply; a first load terminal connected to a high potential side terminal of the load and a second load terminal connected to the second power supply terminal and a low potential side terminal of the load; an input side voltage detection circuit connected between the first power supply terminal and the second power supply terminal, and configured to detect an input side detected voltage based on the power supply voltage; an output side voltage detection circuit connected between the first load terminal and the second load terminal, and configured to detect an output side detected voltage based on an output voltage between the first load terminal and the second load terminal; a primary side winding having one end that is connected to the first power supply terminal, the primary side winding being included in a transformer; a secondary side winding having one end that is connected to the second power supply terminal, the secondary side winding being included in the transformer; a main switch having one end that is connected to another end of the primary side winding and another end that is connected to the second load terminal; an error amplifier configured to output an error voltage based on a difference between the output side detected voltage and a predefined reference voltage; an adder configured to output an addition result signal based on a result of an addition of a timer signal and the input side detected voltage; an output comparator configured to output a comparison result signal based on a result of a comparison between the addition result signal and the error voltage; and a flip-flop circuit having a set terminal to which a signal from another end of the secondary side winding is inputted, a reset terminal to which the comparison result signal is inputted, and an output terminal from which a control signal for turning on or off the main switch is outputted, the method comprising:
outputting, by the adder, the addition result signal based on the result of the addition of the timer signal and the input side detected voltage; and
outputting, by the output comparator, the comparison result signal based on the result of the comparison between the addition result signal and the error voltage.
